(19) United States
(12) Patent Application Publication
(10) Pub. No.: US 2026/0238652 A1
(43) Pub. Date: Aug. 13, 2026

(54) LogMeeting

(71) Applicants: Sandy Anderson, Miami, FL (US); Qaisar Anderson, Miami, FL (US)

(72) Inventors: Sandy Anderson, Miami, FL (US); Qaisar Anderson, Miami, FL (US)

(21) Appl. No.: 19/274,635

(22) Filed: Jul. 20, 2025

Related U.S. Application Data
(60) Provisional application No. 63/673,749, filed on Jul. 21, 2024.

(51) Int. Cl. H04L 9/40; H04L 9/32

(52) U.S. Cl. CPC H04L 63/107; H04L 9/3239; H04L 63/0861

(57) ABSTRACT

A system and method for location-verified meeting attendance. Unlike prior GPS-logging apps, the system seals each record in a Trusted Execution Environment, anchors a hash to a blockchain, and generates a court-ready affidavit filtered by meeting type and date range. The platform captures GPS and photo evidence, alerts a support circle in real time, and exposes tamper-sealed affidavits via a secure web dashboard—streamlining court-mandated compliance.

### CROSS-REFERENCE TO RELATED APPLICATIONS

This application claims the benefit of U.S. Provisional Patent Application No. 63/673,749, filed Jul. 21 2024 at 3:01 PM, entitled “LogMeeting,” the entirety of which is incorporated herein by reference.

### FIELD OF THE INVENTION

The invention relates to electronic documentation and compliance-monitoring systems, and more particularly to a mobile- and web-based platform for digitally capturing, verifying, and managing attendance at court- or program-mandated support meetings.

### BACKGROUND OF THE INVENTION

Individuals under community supervision—such as probation, pre-trial diversion, or drug-court programs—must provide verifiable proof of attendance at support meetings (e.g., Alcoholics Anonymous, Narcotics Anonymous, mental-health therapy).

Existing solutions rely on paper sign-in sheets or handwritten affidavits, which are prone to forgery, loss, and administrative delay.

The inventors confronted this gap while helping a family member satisfy probation terms that required multiple meetings per week. A secure, real-time digital alternative was needed.

### SUMMARY OF THE INVENTION

The invention provides an integrated mobile application, cloud server, and web dashboard that:
1. Captures GPS-verified, photo-verified check-ins;
2. Instantly notifies a support circle of pre-registered contacts;
3. Allows the user to schedule meetings and receive reminders;
4. Generates tamper-sealed affidavits filtered by meeting type and date range;
5. Exposes affidavits and audit logs to authorized administrators via a secure web portal.

### BRIEF DESCRIPTION OF THE DRAWINGS

FIG. 1 depicts a system-architecture diagram including a mobile device, GPS service, notification server, cloud platform with database cluster, and administrative dashboard.

FIG. 2 shows the Mobile-App Home Screen wire-frame.

FIG. 3 shows the Mobile-App Check-In Screen wire-frame.

FIG. 4 illustrates the Web-based Administrative Dashboard UI.

FIG. 5 provides an entity-relationship diagram of users, meetings, check-ins, affidavits, and support contacts.

FIGS. 6A-6B depict affidavit-input and affidavit-preview UIs, respectively.

FIG. 7 illustrates the affidavit-generation, digital-signing, and archival flow.

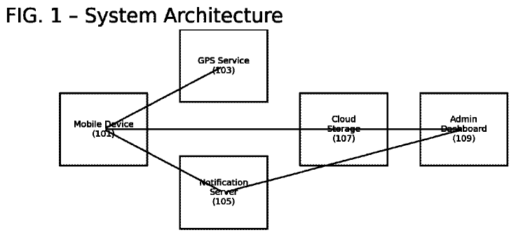

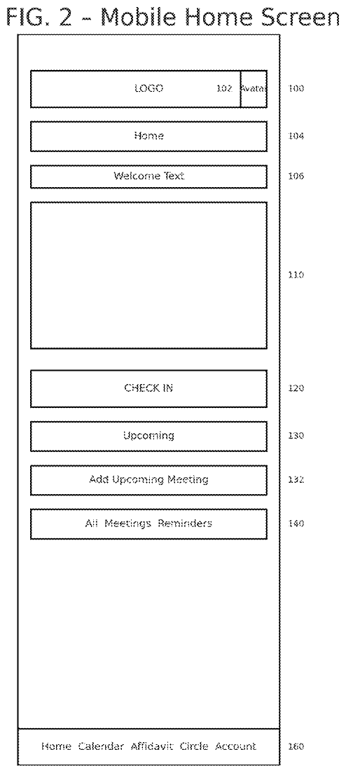

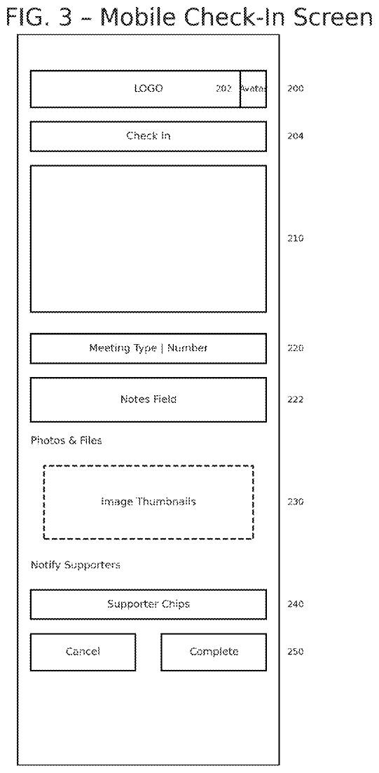

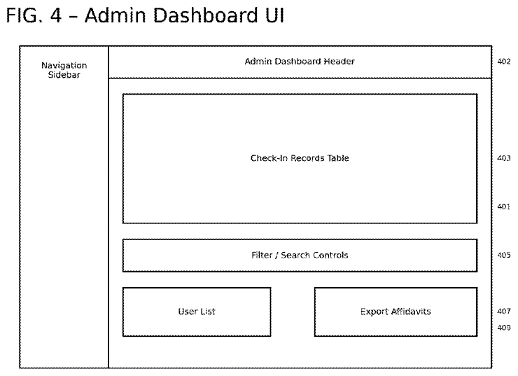

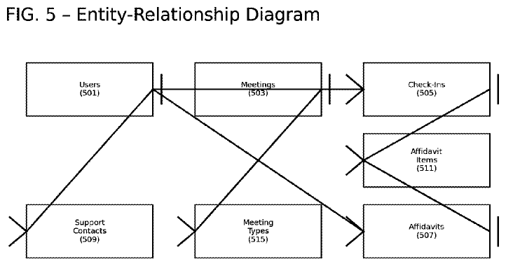

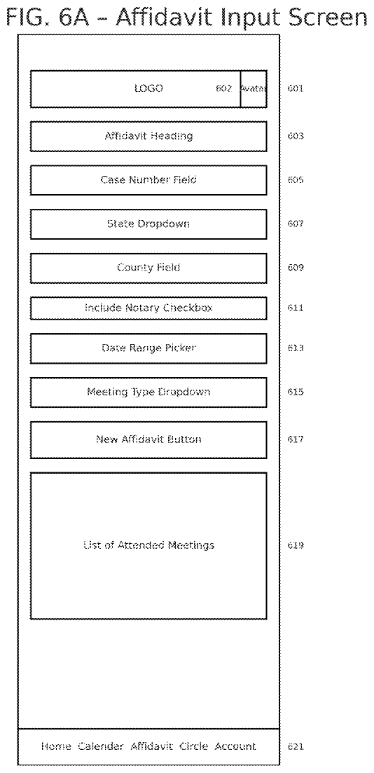

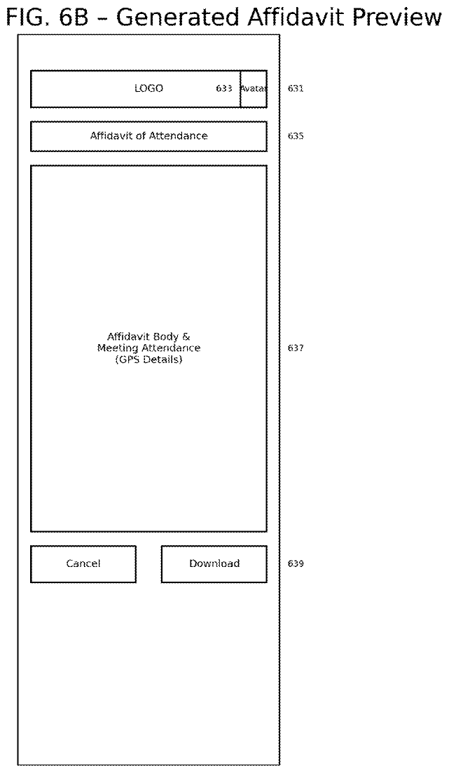

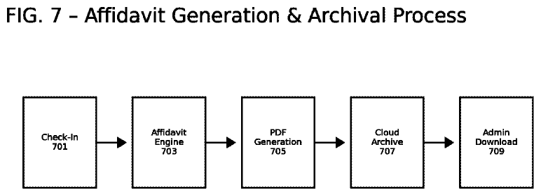

### DETAILED DESCRIPTION OF THE INVENTION

### 1. Mobile Application Module

Native iOS and Android builds provide secure multi-factor authentication.

Check-in workflow captures GPS coordinates, timestamp, live photograph, and meeting metadata.

TEE-Based Security. In one embodiment, the mobile application computes a SHA-256 hash of the attendance record and signs the hash inside a Trusted Execution Environment (TEE) co-processor before transmission, thereby improving end-to-end data-integrity over conventional cloud-only logging.

Sends SMS/e-mail notifications to a plurality of support-circle recipients.

Offline caching with auto-sync on reconnection.

### 2. Cloud Platform & Database Cluster

Receives, encrypts, and redundantly stores check-in data in geographically separated data centers.

Computes a cryptographic hash and anchors it to a distributed ledger for public verifiability.

Generates digitally signed affidavits (PDF, JSON) using meeting-type-specific templates.

Exposes RESTful API endpoints secured by OAuth 2.0. expose affidavit retrieval and audit data.

### 3. Web-Based Administrative Dashboard

Role-based login for probation officers and case managers.

Real-time feed of user check-ins; filter by user, date, meeting type.

Download-only access to user-generated affidavits; immutable audit trail of all actions.

### Advantages Over Prior Art

Forgery-Resistant—GPS geofencing plus TEE hashing and blockchain anchoring eliminate falsified signatures.

Instant Accountability—Real-time support-circle alerts reduce relapse and no-show risk.

Court-Ready Paperwork—User-customizable, hash-sealed affidavits filtered by meeting type and date range cut clerical workload.

Seamless Integration—REST API pushes verified records directly into case-management systems.

A preliminary pilot with 12 probationers over 90 days recorded zero forged sign-ins and a 30 percent reduction in officer administrative time compared with paper logs.

### Operational Use Case

User Authenticates.

At the meeting, taps Check In; the app captures GPS/photo and signs the record in the TEE.

Cloud server stores data and writes a hash to a public blockchain.

Support circle receives SMS/e-mail with a secure link.

Officer views the record in the dashboard and downloads the affidavit for court submission.

### Glossary of Key Terms

Support circle—a set of pre-registered contacts automatically notified of attendance events. Distributed ledger—any blockchain or append-only Merkle-tree ledger anchoring cryptographic hashes of attendance records for independent verification. Anomaly-detection model—a trained machine-learning model receiving latitude/longitude-timestamp tuples and outputting a probability score indicating abnormal check-ins.

### Best Mode for Carrying out the Invention

The preferred implementation employs a React Native mobile app communicating with AWS Lambda microservices and DynamoDB storage, with hardware-security-module key management.

Audit logs reside in Amazon QLDB, and affidavit PDFs are signed with ECDSA-P256 certificates.

System performance is monitored via AWS CloudWatch alarms tied to latency thresholds for check-in processing.

The anomaly-detection model is retrained monthly using newly accumulated check-in data to improve fraud-detection accuracy.

The invention claimed is:

1. A system for electronically documenting and verifying meeting attendance, comprising:
(a) a mobile application executable on a user device and configured to
(i) authenticate a user;
(ii) initiate a check-in procedure at a physical meeting location;
(iii) capture date- and time-stamped Global Positioning System (GPS) coordinates;
(iv) capture and upload at least one contemporaneous photograph; and
(v) transmit electronic notifications to a plurality of pre-registered recipients;
(b) a cloud server comprising a processor and non-transitory memory storing instructions that, when executed, cause the server to
(i) receive, encrypt, and redundantly store check-in data;
(ii) generate a digitally signed affidavit of attendance that includes the check-in data; and
(iii) expose the affidavit through a secure application-programming interface; and
(c) a web-based administrative dashboard configured to authenticate an administrative user and render, filter, and export the affidavit.

2. The system of claim 1, wherein the mobile application prevents the check-in procedure unless the GPS coordinates fall within a predefined geofence surrounding the meeting location.

3. The system of claim 1, wherein the mobile application authenticates the user via biometric identification selected from the group consisting of facial recognition and fingerprint scanning.

4. The system of claim 1, wherein the cloud server stores each attendance record in multiple geographically distinct data centers for fault tolerance.

5. The system of claim 1, wherein the cloud server computes a cryptographic hash of each attendance record and writes the hash to a distributed ledger.

6. The system of claim 1, wherein the affidavit further comprises embedded metadata including device identifier, GPS coordinates, and the cryptographic hash.

7. The system of claim 1, wherein the administrative dashboard logs every affidavit download and data-modification action in an immutable audit trail.

8. The system of claim 1, wherein the notifications transmitted by the mobile application contain a secure hyperlink referencing the affidavit.

9. The system of claim 1, further comprising a calendar-and-reminder module configured to store future meeting schedules and send reminder notifications to the user.

10. The system of claim 1, wherein the cloud server dynamically selects an affidavit template based on a meeting type contained in meeting metadata.

11. A computer-implemented method of documenting and verifying meeting attendance, comprising: (a) authenticating, by a mobile application, a user on a mobile device; (b) capturing, by the mobile application upon user initiation, GPS coordinates and at least one contemporaneous photograph at a meeting location; (c) uploading the GPS coordinates, photograph, and user-supplied meeting metadata to a cloud server; (d) storing, by the cloud server, the uploaded data in redundant storage and computing a cryptographic hash of the data;
(e) generating, by the cloud server, a digitally signed affidavit that includes the uploaded data and the cryptographic hash; and (f) making the affidavit accessible through a web-based administrative dashboard.

12. The method of claim 11, further comprising validating that the GPS coordinates fall within a geofence associated with the meeting location before step (e).

13. The method of claim 11, further comprising transmitting an electronic notification to the plurality of pre-registered recipients immediately after step (b).

14. The method of claim 11, further comprising anchoring the cryptographic hash of step (d) to a distributed ledger.

15. The method of claim 11, wherein the mobile application performs step (b) inside a Trusted Execution Environment co-processor of the mobile device.

16. The method of claim 11, further comprising filtering, by the web-based administrative dashboard, the affidavit accessible in step (f) by meeting type.

17. The method of claim 11, wherein the affidavit generated in step (e) is stored as a Portable Document Format file that includes embedded GPS coordinates and a notary signature block.

18. The method of claim 11, wherein the web-based administrative dashboard records each affidavit download event in an immutable audit trail.

19. The method of claim 13, wherein the electronic notification contains a secure hyperlink referencing the affidavit generated in step (e).

20. The system of claim 1, further comprising an anomaly-detection model trained on at least 500 historical check-ins and configured to flag check-ins having a probability of authenticity below a predefined threshold.

21. The system of claim 1, wherein the mobile application caches check-in data locally when a network connection is unavailable and automatically uploads the cached data to the cloud server upon reconnection.
